(19) United States
(12) Patent Application Publication
(10) Pub. No.: US 2007/0039173 A1
(43) Pub. Date: Feb. 22, 2007

(54) Method and apparatus for staking a hardened shaft

(76) Inventors: Thomas A. Braun, Grandville, MI (US); Venkatasubramanian Ananthanarayanan, Beavercreek, OH (US); James M. Payne, Grand Blanc, MI (US)

Correspondence Address: DELPHI TECHNOLOGIES, INC., M/C 480-410-202, PO BOX 5052, TROY, MI, 48007, US

(21) Appl. No.: 11/197,111

(22) Filed: Aug. 4, 2005

(51) Int. Cl. B21D 53/84; B23Q 3/00

(52) U.S. Cl. 29/888.1; 29/464

(57) ABSTRACT

In a method and apparatus for staking a hardened shaft in bores in a hydraulic lifter body, the shaft is inserted into the bores such that the shaft ends are substantially flush with the bore exits which are slightly chamfered to receive staked material displaced from the shaft. Mechanical rams that also define a first electrode are advanced axially of the shaft into contact with the shaft ends. A second electrode is brought into contact with the lifter body. Electric current is passed between the electrodes, causing resistive heating of the body and the shaft ends. The time and applied amperage are sufficient to cause softening of the shaft ends, at which time the current is switched off, and the first electrode is then driven against the shaft ends, causing the ends to be radially expanded into the chamfers. The remainder of the shaft is not softened nor retempered.

### TECHNICAL FIELD

The present invention relates to methods and apparatus for securing a shaft in a bore by expanding the outer end of the shaft after insertion into the bore, a process known in the art and referred to herein as “staking”; and more particularly, to an improved method and apparatus for mounting a roller and hardened shaft to a body of a roller cam follower device such as a roller hydraulic valve lifter (RHVL) or a roller finger follower (RFF) for an internal combustion engine.

### BACKGROUND OF THE INVENTION

Hydraulic valve lifters (HVL) for internal combustion engines are well known.

One form of hydraulic valve lifter (RHVL) includes a roller for following the surface of a cam lobe with low frictional loss and low wear in a cam-in-block engine. The roller is disposed between first and second spaced-apart lifter body elements and is rotatably mounted on a hardened steel shaft extending through bores in the body. The shaft has a Rockwell C hardness typically of about 60-62.

In the prior art, the shaft is secured to the body by orbital riveting or staking with up to 5000 pounds of mechanical force. Deforming the ends of the shaft by staking is possible only because the ends of the shaft have been retempered to reduce the hardness to an R15N value of about 74-76.

A problem exists in the prior art, in that the ends of the hardened shafts are pre-softened by a supplier to permit mechanical staking thereof and are prone to nicking and damage due to handling prior to assembly into a lifter or follower. Damaged shafts are rejected for lack of fit into a bearing or into the housing bores. Further, the high pressure assembly process can cause the shafts to be driven out of round, also resulting in rejects. Further, the retempering procedure makes the prior art shafts relatively expensive.

This problem exists also in the manufacture of other roller cam follower devices such as the roller finger follower (RFF) in cam-in-head or overhead cam engine and is inherent in all applications requiring staking of the end of a hardened shaft to secure it in a bore.

What is needed in the art is a method and apparatus for staking a hardened steel roller shaft in a roller hydraulic valve lifter or a roller finger follower.

It is a principal object of the present invention to reduce the cost of manufacturing a roller cam follower device.

### SUMMARY OF THE INVENTION

Briefly described, in a method and apparatus for staking a shaft in bores in a shaft-supportive element, for example, a hydraulic lifter body, the shaft is inserted into the bores such that the shaft ends are substantially flush with the bore exits. Preferably, the bore exits are slightly chamfered to receive staked material from the shaft. Mechanical rams that also define a first electrode are advanced axially of the shaft into contact with the shaft ends. A second electrode is brought into contact with the lifter body surrounding the bores. While the first electrode is applying a mechanical load to the ends of the shaft, electric current is passed between the first and second electrodes, causing resistive heating of the shaft ends and the body. The time and applied amperage are sufficient to cause slight softening of the ends of the shaft, at which time the current is switched off, while the mechanical axial load from the first electrode is maintained momentarily to controllably deform the ends of the pin to complete the radial expansion of the pin. The remainder of the shaft is not softened nor retempered by the process.

### BRIEF DESCRIPTION OF THE DRAWINGS

The present invention will now be described, by way of example, with reference to the accompanying drawings, in which:

FIG. 1 is an elevational cross-sectional view of a prior art arrangement for mechanical staking of a roller shaft in a hydraulic valve lifter body;

FIG. 2 is a detailed cross-sectional view of a staked shaft end, showing deformation of the end into a chamfer via either the prior art or a method of the invention; and

FIG. 3 is an elevational cross-sectional view of an apparatus for staking of a hardened roller shaft in accordance with a method of the invention.

### DESCRIPTION OF THE PREFERRED EMBODIMENTS

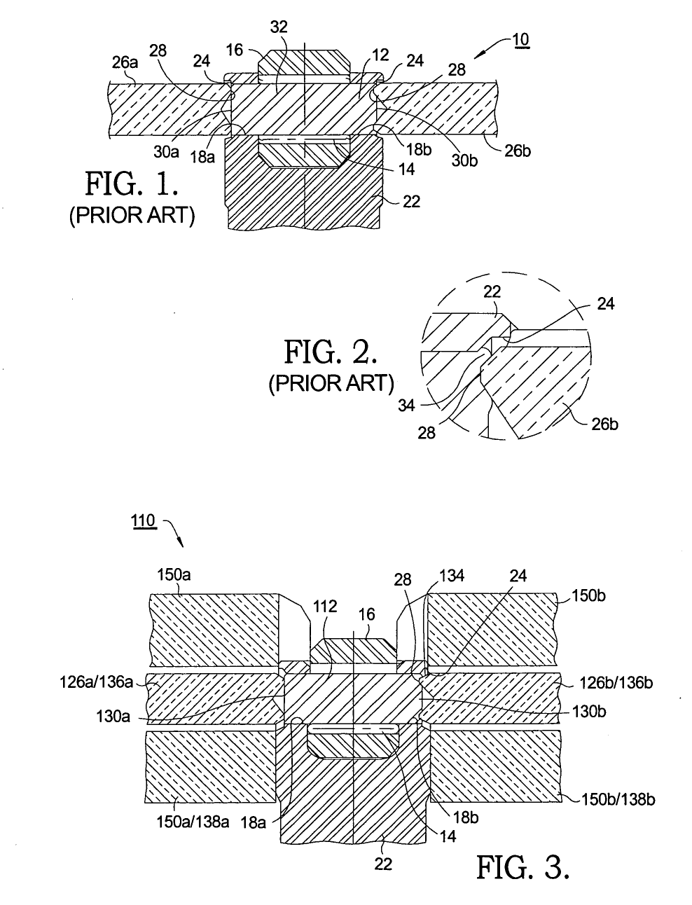

Referring to FIGS. 1 and 2, in a prior art arrangement 10 for staking a roller shaft in a hydraulic valve lifter body, a shaft 12 is supportive of roller bearings 14 and a roller 16. Shaft 12 extends through first and second coaxial bores 18a, 18b formed in lifter 2o body 22. Bores 18a, 18b are chamfered 24 at their outer ends. First and second mechanical rams 26a, 26b having staking features 28 formed on faces thereof are axially actuated at a relatively high pressure, for example, 5000 pounds, against ends 30a, 30b of shaft 12 which extend through chamfers 24. Shaft 12 is unhardened at ends 30a, 30b but is fully hardened in central portion 32 within roller bearings 14 which, as described above, causes shaft 12 to be expensive and delicate to handle without damaging the ends. Shaft 12 is typically at ambient temperature during staking. In FIG. 1, the left end of shaft 12 is shown prior to staking, and the right end is shown after staking. The staking action just described results in a radial protrusion 34 of material displaced from shaft 12 into chamfers 24. When each end of shaft 12 is thus staked, shaft 12 is immobilized within bores 18a, 18b.

Referring to FIG. 3, in an arrangement 110 in accordance with the invention for staking a roller shaft in a hydraulic valve lifter body, a fully hardened shaft 112, having a Rockwell C hardness typically of about 60-62, is supportive of roller bearings 14 and a roller 16. Shaft 112 extends through first and second coaxial bores 18a, 18b formed in lifter body 22 which may be chamfered 24 at their outer ends as in FIG. 1. First and second mechanical rams 126a, 126b having staking features 28 formed on faces thereof are also first electrodes 136a, 136b connected in parallel to a controllable electric source (not shown). Cylindrical fixture elements 150a, 150b surround rams 126a, 126b, are in contact with lifter body 22, and are electrically insulated from first electrodes 126a, 126b. Fixture elements 150a, 150b define second electrodes 138a, 138b connected in series with first electrodes 136a, 1 36b. As in FIG. 1, the left end of shaft 112 is shown prior to staking, and the right end is shown after staking.

When electric current is passed through lifter body 22 and the first and second electrodes, body 22 and shaft ends 130a, 130b are heated by resistive heating to cause the shaft ends to become softened at elevated temperature, at which point the current is turned off. Rams 126a, 126b then are axially actuated against ends 130a, 130b of shaft 112 at a relatively low pressure, which may include first withdrawing the rams from contact therewith, or maintaining a sustained pressure on the ends, resulting in an annular radial protrusion 134 of material displaced from shaft 112 into chamfers 24, similar to the staking shown in detail in FIG. 2. As in the prior art, when each end of the shaft is thus staked, the shaft is immobilized within the bores. The electrodes are withdrawn, and the roller sub-assembly may be passed to the next manufacturing operation.

While the hardness of the pre-softened shaft of the example disclosed is in the range of 60-62 on the Rockwell C scale, it is understood that any hardness as known in the art above that suitable for staking, as a pre-staked hardness, would fall within the scope of the invention.

While the invention as described incorporates the first electrodes 136a, 136b into the mechanical rams 126a, 126b, it is understood the electrode elements and ram elements may be separate members.

The intensity and duration of the electric current varies with the mass and material of the shaft and the body, and the pre-staked hardness of the shaft, and hence must be determined for each individual application. Such determination may be made without undue experimentation and is well within the scope of one skilled in the art.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A method for fixing an end of a hardened shaft in a bore formed in a body, comprising the steps of:
a) providing a ram that is reciprocable of said shaft, said ram defining a first electrode;
b) providing a fixture in contact with said body, said fixture defining a second electrode;
c) positioning said ram in contact with said end of said shaft;
d) passing electricity through said shaft between said first and second electrodes to heat and soften said shaft end.

2. A method in accordance with claim 1 further including the step of urging said ram against said softened shaft end to deform said shaft end radially.

3. A method in accordance with claim 2 wherein said ram is provided with a staking element for engaging said shaft end.

4. A method in accordance with claim 1 wherein said bore is chamfered.

5. A method in accordance with claim 2 comprising the further step of retracting said ram from said shaft end prior to said urging step.

6. A method in accordance with claim 1 wherein said shaft is formed of hardened steel.

7. A method in accordance with claim 1 wherein said body is a cam follower body and wherein said shaft is a roller shaft.

8. A method in accordance with claim 7 wherein said cam follower is selected from the group consisting of a roller hydraulic valve lifter and a roller finger follower.

9. A cam follower having a roller shaft staked in a cam follower body in accordance with the method of claim 1.

10. A method for fixing first and second ends of a hardened roller shaft in first and second bores in a cam follower body for use in an internal combustion engine, comprising the steps of:
a) providing first and second rams that are reciprocable of said shaft, said rams defining a first electrode;
b) providing a fixture in contact with said body adjacent said first and second bores, said fixture defining a second electrode;
c) positioning said first and second rams in contact with said first and second ends, respectively, of said shaft; and
d) passing electricity through said shaft between said first and second electrodes to heat and soften said first and second shaft ends.

11. A method in accordance with claim 10 further including the step of urging said first and second rams against said first and second shaft ends, respectively, to deform said first and second shaft ends radially.

12. A method in accordance with claim 10 wherein said roller shaft including said first and second shaft ends is formed of hardened steel.
